(19) United States
(12) Patent Application Publication
(10) Pub. No.: US 2011/0022497 A1
(43) Pub. Date: Jan. 27, 2011

(54) CREATION AND MAINTENANCE OF AN ELECTRONIC COMMERCE LISTINGS CATALOG

(76) Inventors: Eric Scifres, Los Altos, CA (US); David Vogt, Menlo Park, CA (US); Starlet Susilo, Oakland, CA (US); Jill Sherman, Jamaica Plain, MA (US)

Correspondence Address: NORTH WEBER & BAUGH LLP, 2479 E. BAYSHORE ROAD, SUITE 707, PALO ALTO, CA, 94303, US

(21) Appl. No.: 12/507,728

(22) Filed: Jul. 22, 2009

(51) Int. Cl. G06Q 30/00; G06Q 10/00

(52) U.S. Cl. 705/27.1; 705/10

(57) ABSTRACT

A dynamic listings catalog may be generated from a plurality of auction listings to allow a more robust user experience in viewing these catalogs, a more personalized grouping of ecommerce items, and facilitate rendering and embedding within a third party website. A listings catalog is defined as a compilation of ecommerce listings within a rich media environment and does not require page-by-page loading of listing sites as a user sequences through them. One natural consequence of the ability to dynamically group and catalog listing sites is that micro-communities may be developed. A micro-community is defined as a group of users (either sellers or buyers) that share one or more commonalities and that are integrated together to facilitate ecommerce within the grouping.

### BACKGROUND

A. Technical Field

The present invention pertains generally to a dynamic catalog for electronic commerce, and relates more particularly to the creation and maintenance of a dynamic catalog from a plurality of distinct electronic commerce listings, such as internet auctions.

B. Background of the Invention

The significance of electronic commerce in today's society is well understood by one of skill in the art. Electronic commerce has transitioned from a cottage industry into a source of significant revenue for many different types of merchants. This growth in the electronic commerce market can be attributed to a number of different factors including technological advancements, the ability of vendors to introduce products to a large number of potential purchasers, the manner in which inventories are managed and the structure in which transactions are structured.

Internet auctions represent one type of electronic commerce and are illustrative of the exponential market growth of internet-based transactions. Auction sites provide a platform and procedure on which an independent vendor auctions his/her goods over the internet to a large number of potential purchasers. The viability of an internet auction site greatly depends on its ability to create an environment of transactional transparency and procedural integrity so that participants, both vendor and purchaser, are comfortable transacting. Because a seller and a purchaser are unable to perform a face-to-face transaction, it is important that an internet auction site develop a reputation of trust. Developing such a reputation requires a significant investment in creating an infrastructure that promotes transparent and successful transactions. There have been relatively few auction sites that have successfully developed this reputation on a large-scale, which has resulted in very few internet auction sites being able to support online auctions across a diverse set of products and participants in very high volumes.

eBay is recognized by a large number of online sellers and purchasers as one of the prevalent internet auction sites. In developing this reputation, eBay has created infrastructure and procedures that supports easy and transparent auctions, transaction histories of participants, and transactional security measures. eBay auctions a very large and diverse set of goods on its site and services numerous sellers and purchasers throughout the globe. The enormity of the eBay auction site has generated significant amounts of transactions and revenue derived therefrom. However, this enormity has also limited eBay's ability to provide certain users a more-personalized and localized auction experience.

The eBay site is designed to organize and auction goods at a global-scale. The size of eBay offers its users an extremely large amount of auctions across a diverse set of items. At any one time, eBay may have hundreds or thousands of active auctions of a single type of item. Going through these active auctions can be a daunting task for certain users as well as require a significant amount of time. Although eBay provides certain searching functionality, a normal search may generate hundreds of returns and effectively bury the most relevant items within an extensive list of hits. For many potential users, going through such a search return is not an effective way for the most relevant auctioned items to be identified.

The eBay site also provides limited grouping of auctions. The primary example of groups of listings is an eBay Seller Store in which a user's auctions are grouped together in separate listing pages. These Seller Stores are static groupings in which a user has to click through different distinct auction pages to view each listing. Additionally, other features of auction listings are not automatically grouped together and can only be identified around a characteristic by performing an eBay search. For example, a purchaser may want to buy a particular item from a local vendor that satisfies particular criteria. Once again, the eBay search engine may be less ideal in identifying such vendors because reviewing the search return may be complex, time consuming and may potentially generate incomplete search results.

Accordingly, what is desired is systems, devices and methods that generate and maintain dynamic listing categories that provide a more personalized and/or localized group of listings. Additionally, it is also desired that these dynamic listing categories be constructed to allow a user to review and interact with these listings in a more robust manner without having to load and view distinct listing pages.

### SUMMARY OF THE INVENTION

A dynamic listings catalog may be generated from a plurality of ecommerce listings to allow a more robust user experience in viewing these listings, a more personalized grouping of items for both a purchaser and a seller, and facilitate embedding within a third party website. A listings catalog is defined as a compilation of ecommerce listings within a rich media environment. For example, a group of listings may be combined into a flash-based environment that allows a user to quickly sequence through ecommerce listings as well as provide rich media functionality that supports the catalog presentation. Specific listing catalog may be grouped according to various parameters and/or search criteria. In many instances of the invention, a listing catalog represents a pre-filtered and robust visualization of related auction listings within an auction site(s), such as eBay.

In various embodiments, the categorization and information within each of the listings in the catalog may be generated and rendered within a third-party website using data derived from each of the listings, the auction listings themselves, metadata within the listings, and user-provided information. The categorization of the listings as well as the synthesis of listing information within a rich media environment creates an auction or electronic commerce experience superior to those currently available in the prior art.

In certain embodiments, the catalog is pre-fetched, cached locally on a computer and rendered within a rich media window embedded within a third party site. Rendering information for the catalog is used to render the catalog within the third party site and present the catalog in a particular layout. Certain information within the catalog may be intermittently updated from either a rich media server and/or a listings server to ensure data provided the user is current.

One natural consequence of the ability to dynamically group and catalog listing sites is that micro-communities may be developed. A micro-community is defined as a group of users (either sellers or buyers) that share one or more commonalities and that are integrated together to facilitate ecommerce within the grouping. These micro-communities may be automatically generated based on an analysis of a set of users such that a sub-set of users are identified or may be manually created and maintained by managing users in which each community member is granted entry.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates an exemplary method of creating a dynamic catalog from a plurality of distinct listing pages according to various embodiments of the invention.

FIG. 2 depicts the maintenance of a dynamic catalog embedded within a third-party website according to various embodiments of the invention.

FIG. 3 illustrates examples of types of information within a dynamic catalog that are updated from a listings server according to various embodiments of the invention.

FIGS. 4A and 4B illustrate exemplary catalog pages having multiple listings according to various embodiments of the invention.

FIG. 5 illustrates a method in which a listings catalog is created from distinct listings according to various embodiments of the invention.

FIG. 6 illustrate a method in which a catalog is created, embedded and maintained within a third part website according to various embodiments of the invention.

FIG. 7 depicts a block diagram of an exemplary computing system on which certain embodiments of the invention function and are tangibly operable.

FIG. 8 depicts the generation of a micro-community and the inclusion of at least one dynamic listings catalog therein according to various embodiments of the invention.

FIG. 9 depicts the maintenance of a dynamic listings catalog within the micro-community according to various embodiments of the invention.

FIG. 10 depicts the rendering and maintenance of a listings catalog within a third party website according to various embodiments of the invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or a combination thereof. Accordingly, the flow charts described below are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

A. Overview

A dynamic listings catalog may be generated from a plurality of ecommerce listings to allow a more robust user experience in viewing these listings, a more personalized grouping of items for both a purchaser and a seller, and facilitate embedding within a third party website. A listings catalog is defined as a compilation of ecommerce listings within a rich media environment. For example, a group of listings may be combined into a flash-based environment that allows a user to quickly sequence through auction listings as well as provide rich media functionality that supports the catalog presentation. Specific listing catalogs may be grouped according to various parameters and/or search criteria. In many instances of the invention, a listing catalog represents a pre-filtered and robust visualization of related auction listings within an auction site(s), such as eBay.

In certain embodiments, the catalog can be generated with minimal or without any interaction from the user using metadata from the contained auction listings, from the seller's information, or inferred from the metadata available. The user has the option of adding additional content, and/or customizing the automatically generated listing catalog. For example, a user may want to generate a listings catalog for his/her fashion-related auctions. By selecting the fashion category, a listings catalog is automatically created for fashion-related auction listings, a table of contents is automatically generated from the listings metadata, and an “about me” page is created using data inferred by the seller's personal information. Once generated, the user has the option of creating additional pages that showcase the product in fashion shows, or modifying existing parts of the catalog. The present invention allows for variable amounts of user interaction and design in creating the catalog from completely designing the catalog to employing catalog templates that can automatically create the catalog based on the listings being integrated within the catalog.

In various embodiments, the categorization and information within each of the listings in the catalog may be generated from rich media template-based listings, auction listings, metadata within the listings, and user-provided information. The categorization of the listings as well as the synthesis of listing information within a rich media environment creates an auction or electronic commerce experience superior to those currently available in the prior art.

In certain embodiments, the catalog is pre-fetched, cached locally on a computer and presented to a user within the flash environment. Certain information within the catalog may be intermittently updated from either a rich media server and/or a listings server to ensure data provided the user is current.

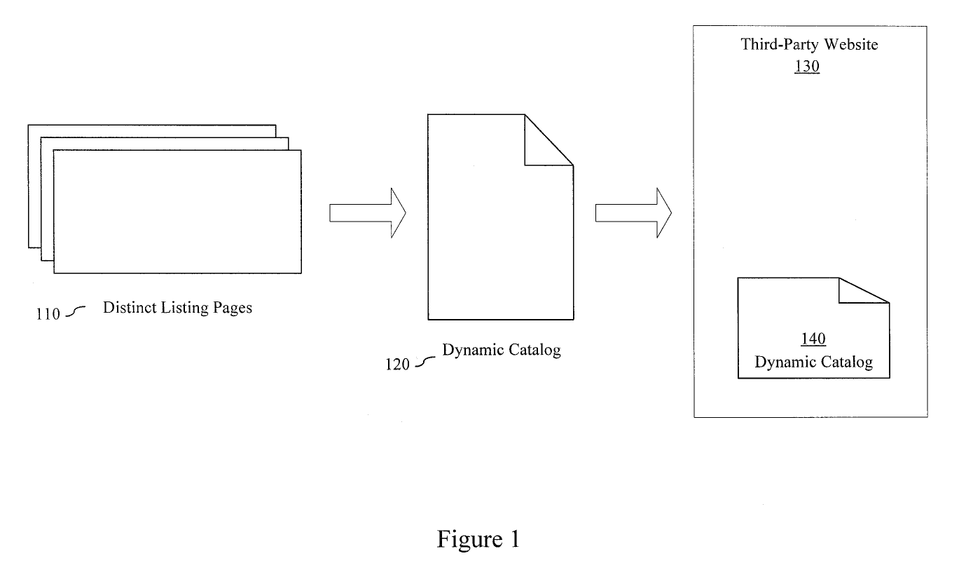

FIG. 1 generally illustrates the creation and display of a listings catalog from a plurality of auction listings according to various embodiments of the invention. A distinct set of listings pages 110 are identified for combination into a catalog. This selection of the listings pages may be performed relative to automated search criteria or user-defined parameters. For example, a first set of listings may be identified relative to the location of a seller (e.g., selected based on a set of seller zip codes) and type of items being auctioned. This first set of listings may be further reduced by applying user-defined parameters, such as accepting only recognized or member sellers within a community, resulting in the distinct set of listings 110 being identified. In other embodiments, the selection of the set of listings 110 may be manually performed by a user.

The distinct set of listings 110 are compiled into a single dynamic catalog 120 that allows a robust presentation to the user. As discussed above, the dynamic catalog 120 may be integrated within a rich media environment to allow a more user-friendly compilation of the auction listings. This rich media presentation and tailored selection of auction sites provides a more robust grouping of auction information relative to the enormous search results generated by simple searching on eBay or eBay Seller Stores.

In certain embodiments of the invention, the dynamic catalog 120 is embedded within a third-party website 130. The embedded catalog 140 may be rendered to both visually fit within the third-party website 130 as well as allow communication between the embedded catalog 140 and web servers. As will be discussed later, this communication will allow for information within the embedded catalog 140 to be updated so that data provided to a user is current.

One skilled in the art will recognize that the embedded catalog 140 may be modified in various way including its “look and feel” to better align itself with the third-party website 130 as well as providing certain functionality to enhance the user experience and ensure data integrity.

B. Embedded Catalog

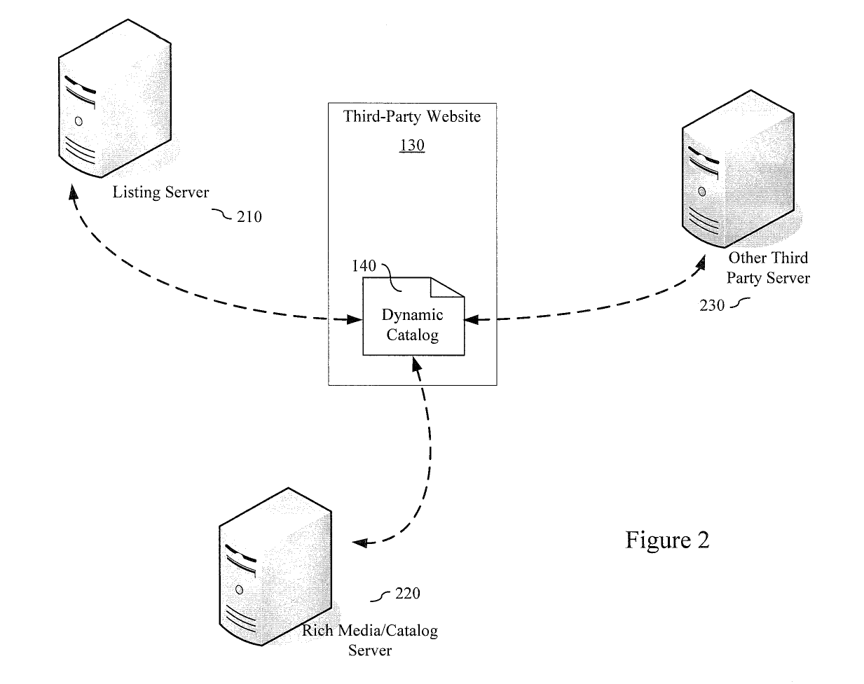

FIG. 2 illustrates an architecture on which the embedded catalog 140 receives information according to various embodiments of the invention. As shown, the catalog 140 embedded within the third-party website 130 interfaces with a plurality of different web servers. In a first instance, the catalog 140 communicates within a rich media/catalog server 220 that provides information such as, but not limited to, rendering information and catalog data (e.g., the listings included within the catalog). Rendering information is defined as structured data that describes the catalog to be rendered. Rendering information may include, but is not limited to, (1) collection of pages that make up the catalog to be rendered; (2) a list of components to be used on each page; (3) configuration data for each component instance which identifies how the component should function, where any external resources should be fetched from, and how to handle certain actions performed with the widget; (4) visual data for each component instance which identifies how the renderer should make the component appear on screen, including, but not limited to, color, size, theme, transparency, orientation, and placement. Furthermore, this rendering information may also include installation/embedding data, rich media functionality, prioritization of listings, location of listings, security, and user monitoring.

The catalog 140 also communicates with a listing server 210 that updates particular information within the listings themselves. For example, the listing server 210 may provide current data relative to the auction status, price, etc. In certain instances, the catalog 140 may also communicate with other third-party servers 230 to include certain types of information within the catalog 140. This communication may be performed via web services, remote API integration, rich widget inclusion or other methods known to one of skill in the art.

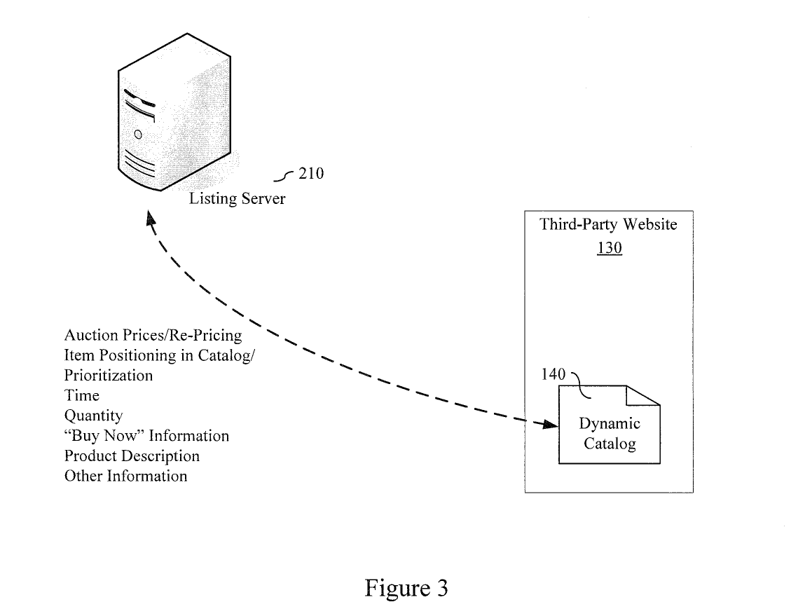

FIG. 3 specifically illustrates a connection between the embedded catalog 140 and the listing server 210. In certain embodiments, the embedded catalog 140 interfaces with a single listing server 210 and in other embodiment, the embedded catalog 140 may interface with multiple listing servers to create a catalog that compiles listings across multiple ecommerce sites. In some examples, certain listing servers need to be pre-qualified to allow corresponding listings to be included within the embedded catalog 140.

These connection(s) allow current data for the listings within the catalog 140 to be intermittently updated so that current information is provided to a user. For example, as shown in this figure, auction prices, time remaining, quantities, “Buy Now” information, product description and other information may be retrieved from the listing server 210. In addition, information may be retrieved that affect the prioritization or location of a listing within the catalog. One skilled in the art will recognize that other information may also be retrieved from the listing server 210 and used to update or otherwise supplement the embedded catalog 140. For example, in other embodiments of the invention, a listings server may have an application that effectively pushes auction information to the catalog 140.

In certain embodiments of the invention, the embedded catalog 140 may have links to the specific auction listing sites on the listing server 210 so that a bid or purchase may be performed. In other embodiments of the invention, the embedded catalog may have functionality to allow a user to bid or purchase locally in the embedded catalog 140. In so doing, a secure connection is established between the catalog 140 and the listing server 210 so that this exchange of information may be performed. In such an instance, a user may be able to not only bid/purchase but also provide credit card or secure transaction information so that the transaction may be completed within the confines of the rich media catalog.

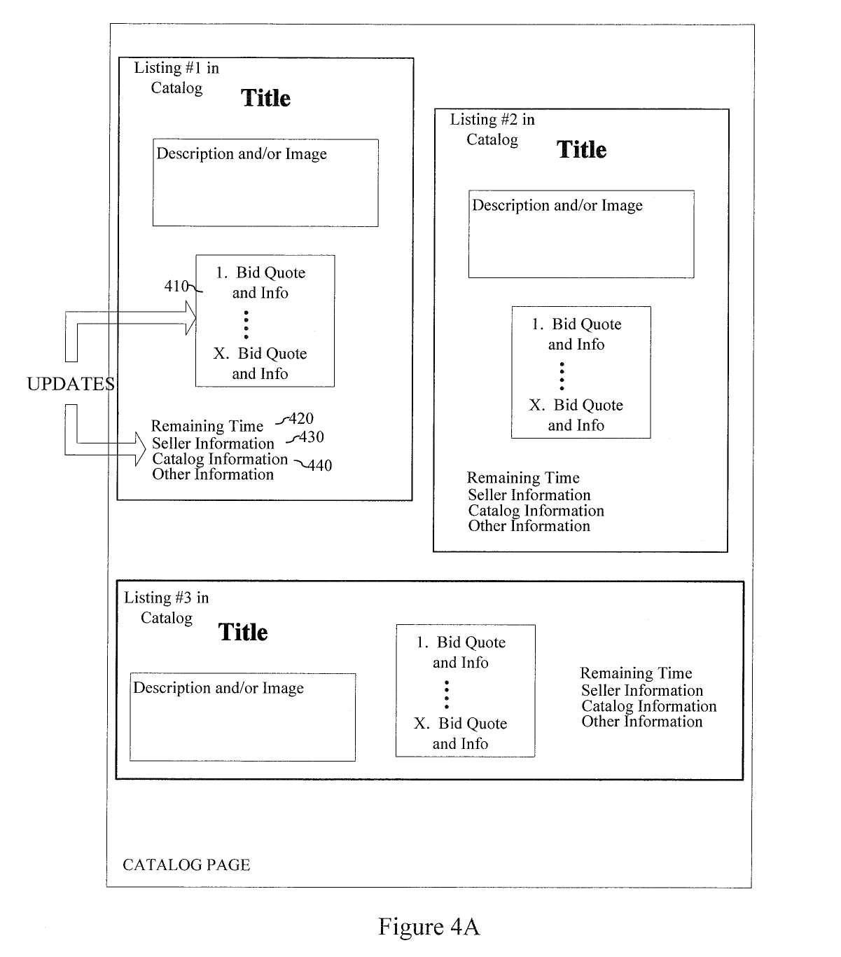

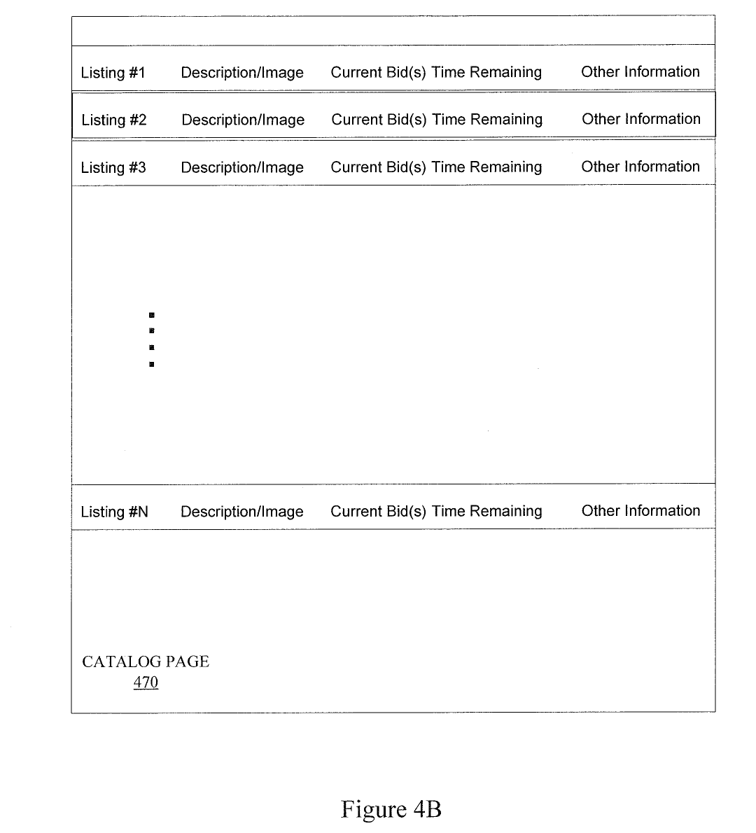

FIG. 4A illustrates an exemplary catalog page having multiple listings according to various embodiments of the invention. In this example, the catalog page contains three listings. In some embodiments, the information within these exemplary listings is manually provided by a user. In certain other embodiments, the information within these exemplary listing is derived from template-based listings in which web design and metadata are provided a user to build a dynamic auction listing. For example, see U.S. Provisional Application Ser. No. 61/226,655 entitled “System and Method for Conducting Transactions from a Third Party Website,” filed Jul. 17, 2009, which application is incorporated by reference in its entirety. These listings may have different pricing schemes such as property-based pricing and proximity-based pricing as described in the above-mentioned provisional application.

In various embodiments of the invention, information embedded within a rich media catalog listing may also be retrieved and/or updated from the listing server 210 or media server 220 as previously discussed. For example, current bid information 410 may be intermittently retrieved from the listing server to be provided within the catalog. Additionally, time information 420, seller information 430, catalog information, 440 or other information may be retrieved from the servers previously described. The relative location of the listings within the catalog page may change over time depending on the relative prioritization of the listings, completed transactions/availability of listed items, etc.

FIG. 4B illustrates another catalog page 470 having multiple listings according to various embodiments of the invention. In this example, a relatively larger number of listings are provided in a row/column format. Once again, the relative position of these listings may change over time and are updated so that current data is provided to the user.

One skilled in the art will recognize that various catalog page and listing layouts and designs as well as catalog designs may be implemented in accordance with various embodiments of the invention. As previously described, the catalog is provided in a rich media environment in which a compilation of listings is provided to a user without having to click through and load each listing sequentially.

C. Generation of a Listings Catalog

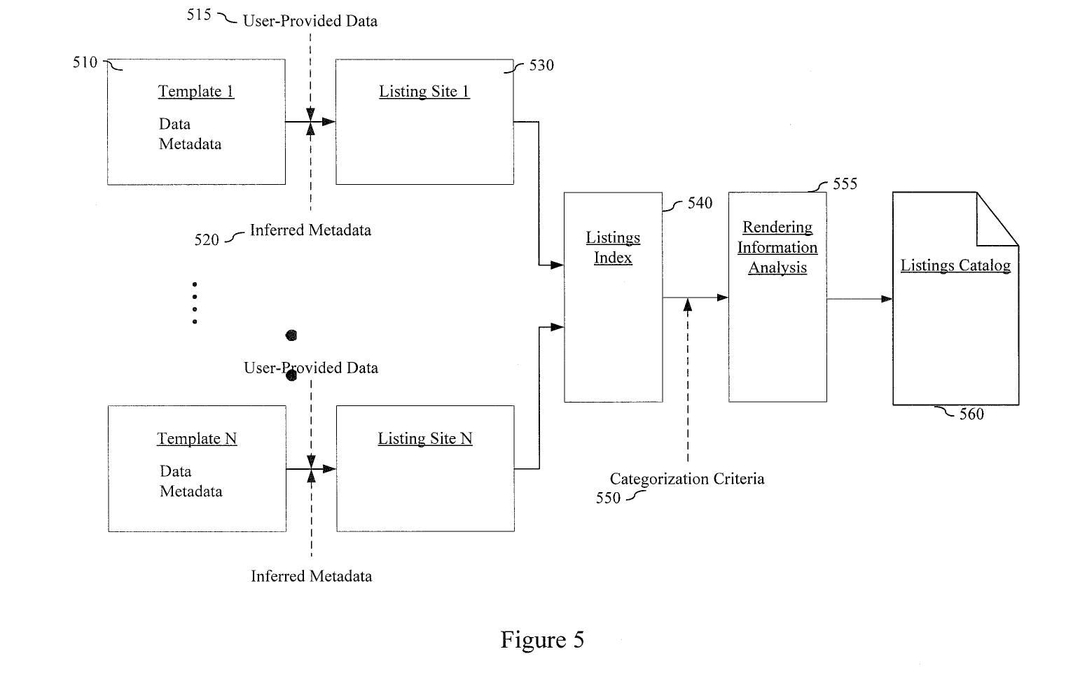

FIG. 5 generally illustrates the generation of a listings catalog according to various embodiments of the invention. In this particular example, the catalog is generated from a plurality of rich media listings that were created using listing templates. However, one skilled in the art will recognize that other listings, including static auction listings, may be used to generate the catalog.

In certain embodiments, the listing sites are manually created by a user and subsequently embedded within a listings catalog. In other embodiments, a plurality of templates is provided to a user from which a first template is selected to generate a rich media listing. These templates 510 may relate to certain listing characteristics such as item types (e.g., sports items, electronic items, etc.), themes (e.g., items related to a particular movie or musical group), or other characteristic relevant to an auction listing. In each of these templates 510, data is pre-embedded within the template that relates to the template. Additionally, metadata is also pre-embedded within the template. One skilled in the art will recognize that different amounts and types of data and metadata may be pre-embedded within each of the templates.

A listing is created 530 based on user inputs (in either case of being automatically generated, manually generated, or a combination thereof). In so doing, user-provided data 515 is integrated into a specific listing 530. This user-provided data may include, but is not limited to, an item title and description, auction parameters (minimum bid, time, bid increments, etc.), seller information, images, etc. In addition, inferred metadata 520 may be generated based on the user-provided data that further supplements the data provided by the user. This inferred metadata may relate to auction parameters, product description, seller information, etc.

Using the data and metadata, the plurality of listing sites (listing site 1 though listing site N) are analyzed and a listings index 540 is generated. In various embodiments of the invention, the listings index 540 is a tree hierarchy in which data and metadata are associated across the plurality of listing sites. However, one skilled in the art will recognize that different index structures may be used in accordance with embodiments of the invention.

Categorization criteria 550 are applied to the listing index 540 to generate a listings catalog 560 specific to this criteria 550. For example, criteria may be applied to the listing index 540 related to seller location, type of item being sold, and minimum bid. A resulting catalog 560 is generated from those listing sites that meet each of these criteria. As previously discussed, the catalog 560 operates in a rich media environment, such as being a flash-based application, and provides the user a robust and filtered view of relevant listings that were combined into the catalog 560. To enable a preferred integration within a website, rendering information 555 is identified and analyzed so that the catalog 560 may be rendered within a site. As previously discussed, this rendering information is different than the actual data within the listings and is used for visualization of the catalog within a rendering window. One skilled in the art will recognize that numerous different catalogs may be generated from the listings index 540 by varying the categorization criteria 550 applied to the index 540. Additionally, as discussed above, the catalog may be integrated and maintained in various different third-party websites and retrieve information from different servers.

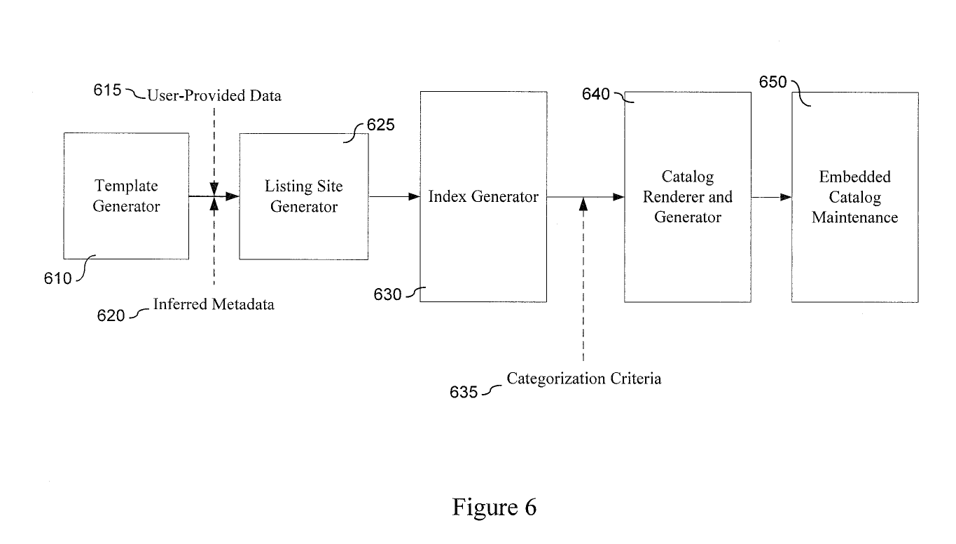

FIG. 6 illustrates exemplary structural software modules, implementable within a computing system described below, that tangibly alter the computer during their operation thereon.

In certain embodiments in which templates are used, a template generator 610 generates a plurality of templates from which a user may select one or more appropriate templates relative to an auction item(s). The templates contain pre-embedded data and metadata that allow a user to input information to generate an auction listing. This data and metadata may relate to specific text and images (and the location thereof within the listing), an overall “look and feel” of the auction listing, auction procedures, data retrieval protocol from third-party servers, and association of the resulting listing to one or more micro-communities, which will be discussed later.

In certain embodiments, the template generator 610 creates flash-based templates or used in combination with an editor written in flash that allow a user to easily input data and dynamically build a listing site. One skilled in the art will recognize other rich media applications may be used to create an environment in which a user is able to build these listing sites. An important characteristic of the templates is the embedded metadata that allows for a dynamic analysis of the listing site and a more-complete representation of the site within an index.

One skilled in the art will recognize that a listing site may be generated manually by a user building the site using various tools. A part of this process will include the user providing certain data about item(s) being sold on the listing site.

As previously described, user-provided data 615 (and perhaps a template) are provided to a listing site generator 625 so that a corresponding listing site is created. Additionally, inferred metadata 620 may be provided to the listing site generator 625 or generated by the listing site generator 625 in response to the user-provided data 615 (and the template if applicable). In certain embodiments, the listing site is generated in a flash-based environment.

The listing site generator 625 may create the listing site using various methods in which the user-provided data and inferred metadata are processed. The user provided data, and the inferred metadata may then be modified by the user to achieve a specific “look and feel” for the listing. One skilled in the art will recognize that there are other procedures in which the listing site may be generated; all of which fall within the scope of the present invention.

The listing site is provided to an index generator 630 that processes the data and metadata within the listing site to integrate it within a listings index. In certain embodiments, the index generator 630 inserts data and metadata related to the listing site into a pre-existing hierarchical index.

A catalog renderer and generator 640 receives both the index and categorization criteria 635 so that a catalog may be generated and rendered within a website. This generated catalog is specifically related to the categorization criteria and allows listing sites within the index to be categorized at different granularities. For example, a first categorization criteria 635 may result in a very narrow set of results in which a small catalog of listings is produced. Comparatively, a second categorization criteria 635 may return a large number of results and produce a large catalog of listings.

As previously discussed, the listings catalog is rendered in a media rich environment so that a robust presentation of the listings is provided to a user. For example, a flash-based catalog may be generated and displayed within a rendering window in which the listings are pre-fetched and loaded, well-organized, and intermittently updated so that a user can easily review and interact with the listings therein.

An embedded catalog maintenance module 650 may maintain the catalog within a third-party website. In certain embodiments, the embedded catalog maintenance module 650 is located on a rich media server and communicates with the embedded catalog over a networked connection. The embedded catalog maintenance module 650 controls and updates the catalog using this connection to ensure that the catalog is current, properly maintained and monitored. In certain embodiments, this management is performed on a control site. However, one skilled in the art will recognize that the embedded catalog maintenance module 650 may be in various locations depending on the specific architecture and security of the third party site.

One skilled in the art will recognize that the above described system may operate on various types of computing systems. Certain computing system implementations are described below.

D. Computing System Implementations

It shall be noted that the present invention may be implemented in any instruction-execution/computing device or system capable of processing data, including without limitation, a general-purpose computer and a specific computer, such as one intended for data processing. The present invention may also be implemented into other computing devices and systems. Furthermore, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

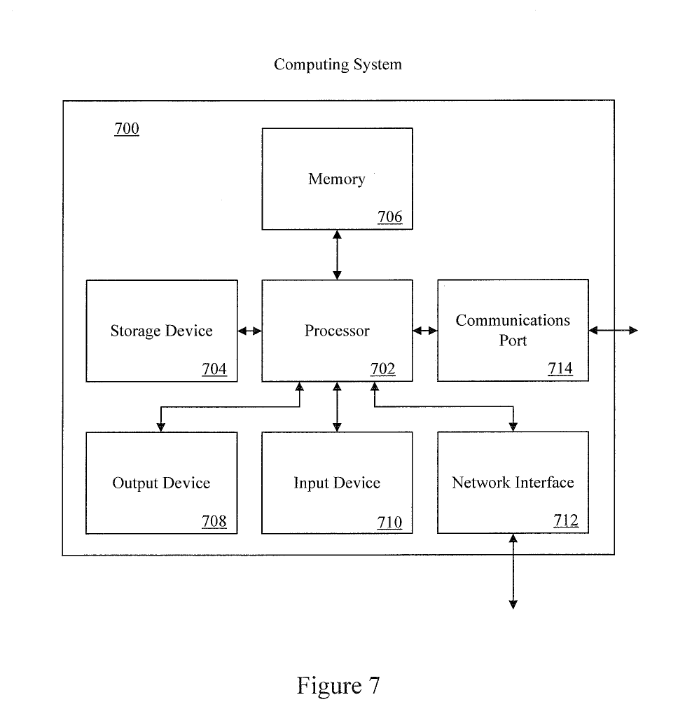

FIG. 7 depicts a functional block diagram of an embodiment of an instruction-execution/computing device 700 that may implement or embody embodiments of the present invention. As illustrated in FIG. 7, a processor 702 executes software instructions and interacts with other system components. In an embodiment, processor 702 may be a general purpose processor such as (by way of example and not limitation) an AMD processor, an INTEL processor, a SUN MICROSYSTEMS processor, or a POWERPC compatible-CPU, or the processor may be an application specific processor or processors. A storage device 704, coupled to processor 702, provides long-term storage of data and software programs. Storage device 704 may be a hard disk drive and/or another device capable of storing data, such as a magnetic or optical media (e.g., diskettes, tapes, compact disk, DVD, and the like) drive or a solid-state memory device. Storage device 704 may hold programs, instructions, and/or data for use with processor 702. In an embodiment, programs or instructions stored on or loaded from storage device 704 may be loaded into memory 706 and executed by processor 702. In an embodiment, storage device 704 holds programs or instructions for implementing an operating system on processor 702. In one embodiment, possible operating systems include, but are not limited to, UNIX, AIX, LINUX, Microsoft Windows, and the Apple MAC OS. In embodiments, the operating system executes on, and controls the operation of, the computing system 700.

An addressable memory 706, coupled to processor 702, may be used to store data and software instructions to be executed by processor 702. Memory 706 may be, for example, firmware, read only memory (ROM), flash memory, non-volatile random access memory (NVRAM), random access memory (RAM), or any combination thereof. In one embodiment, memory 706 stores a number of software objects, otherwise known as services, utilities, components, or modules. One skilled in the art will also recognize that storage 704 and memory 706 may be the same items and function in both capacities. In an embodiment, one or more of the components of FIGS. 5 and 6 may be modules stored in memory 704, 706 and executed by processor 702.

In an embodiment, computing system 700 provides the ability to communicate with other devices, other networks, or both. Computing system 700 may include one or more network interfaces or adapters 712, 714 to communicatively couple computing system 700 to other networks and devices. For example, computing system 1000 may include a network interface 712, a communications port 714, or both, each of which are communicatively coupled to processor 702, and which may be used to couple computing system 700 to other computer systems, networks, and devices.

In an embodiment, computing system 700 may include one or more output devices 708, coupled to processor 702, to facilitate displaying graphics and text. Output devices 708 may include, but are not limited to, a display, LCD screen, CRT monitor, printer, touch screen, or other device for displaying information. Computing system 700 may also include a graphics adapter (not shown) to assist in displaying information or images on output device 708.

One or more input devices 710, coupled to processor 702, may be used to facilitate user input. Input device 710 may include, but are not limited to, a pointing device, such as a mouse, trackball, or touchpad, and may also include a keyboard or keypad to input data or instructions into computing system 700.

In an embodiment, computing system 700 may receive input, whether through communications port 714, network interface 712, stored data in memory 704/706, or through an input device 710, from a scanner, copier, facsimile machine, or other computing device.

One skilled in the art will recognize no computing system is critical to the practice of the present invention. One skilled in the art will also recognize that a number of the elements described above may be physically and/or functionally separated into sub-modules or combined together.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a computer. Examples of program modules include libraries, programs, routines, objects, components, and data structures. In distributed computing environments, program modules may be physically located in settings that are local, remote, or both.

E. Micro-Communities

One natural consequence of the ability to dynamically group and catalog listing sites is that micro-communities may be developed. A micro-community is defined as a group of users (either sellers and/or buyers) that share one or more commonalities and that are integrated together to facilitate ecommerce within the grouping. These micro-communities may be automatically generated based on an analysis of a set of users such that a sub-set of users are identified or may be manually created and maintained by managing users in which each community member is granted entry.

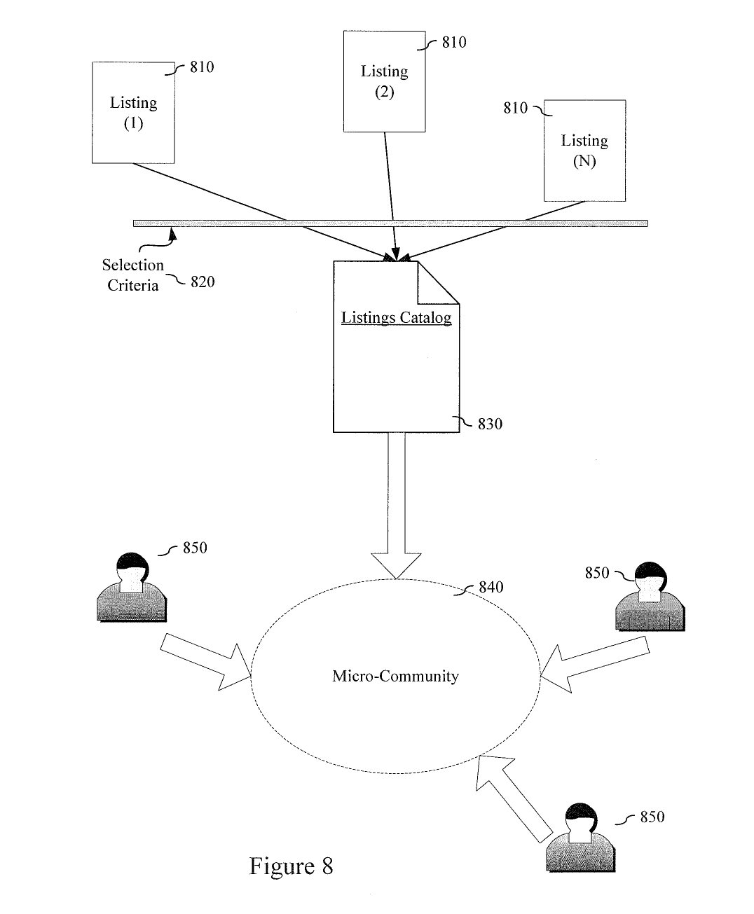

FIG. 8 illustrates an exemplary micro-community and its relationship to a listings catalog according to various embodiments of the invention. As shown, a plurality of listings (i.e., listings 1-N) 810 is selected in accordance with selection criteria 820. These listings 810 are combined into a listings catalog 830, one method of this combination and grouping being described previously.

Because these listings catalog 830 can be generated relative to a numerous different criteria, certain groups of people may be identified for which the listing catalog 830 may be more relevant. As a result, an electronic commerce micro-community or micro-communities may be created 840 to facilitate more personalized or localized transacting between members of the community. In various embodiments of the invention, entry into a micro-community 840 is provided by an automated process during which one or more commonalities across a user group are identified and those users 850 sharing this commonality are combined into the micro-community 840. In other embodiments, entry into the micro-community 840 is granted by a community manager that analyzes entry requests by potential members and grants access based on certain criteria.

Once a micro-community 840 has been setup, membership within the community may be expanded or reduced overtime. The micro-community 840 may support various types of internet transactions including the sales/auction of goods, services and other transactions recognized by one of skill in the art. The micro-community 840 may have multiple listing catalogs therein that allow its members access to more-relevant, robustly-synthesized listing catalogs than previously available on large internet auction sites. For example, a micro-community may be created for golf players within the San Jose area. Listing catalogs may be created and maintained that sell golf merchandise from vendors within the San Jose area. As a result, members of the micro-community can quickly review the golf-related auctions from local vendors and submit bids as desired.

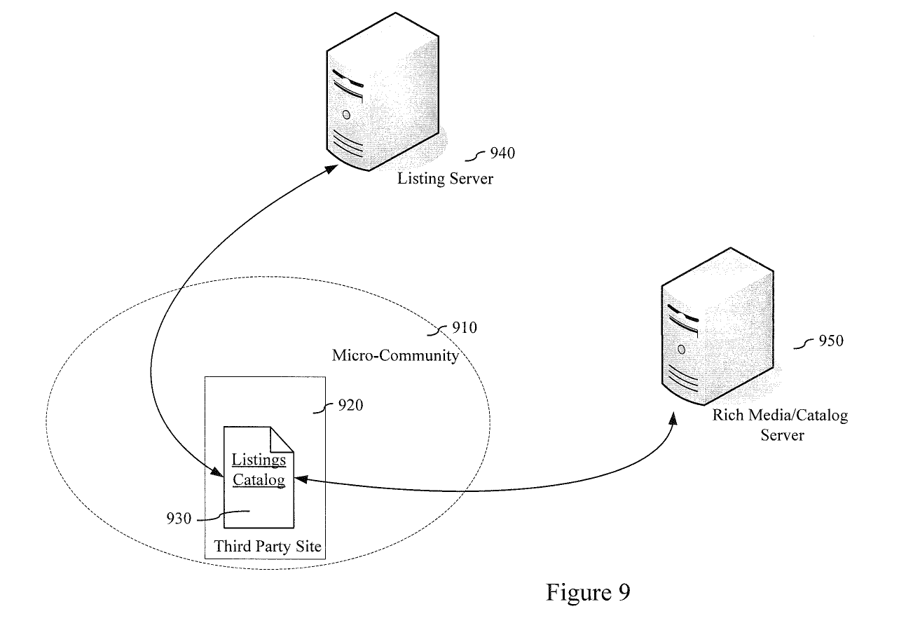

FIG. 9 illustrates the maintenance of a listings catalog within a micro-community according to various embodiments of the invention. In this example, a listings catalog 930 is embedded within a third-party website 920. The third-party website 920 may be associated with a micro-community 910 and/or relevant to members of the micro-community 910. For example, the listings catalog 930 may be embedded within a golf course website, which is associated with a local community of golfers.

The listings catalog 930 may be updated by both a rich media server 950 and a listing server 940. The listing server 940 updates auction information, including current bids and time remaining, on each of the listings within the catalog 930. In one embodiment of the invention, the listings are updated from a single listing auction site. In another embodiment, the catalog 930 is a compilation of listings across a plurality of internet auction sites and each of these auction sites is polled to ensure current data is provided in the listing catalog 930.

The rich media server 950 provides rich media updates as functionality and manages the catalog 930. For example, the rich media server 950 may add or remove certain listings from the catalog 930 over the life of the catalog. One skilled in the art will recognize that other content and functionality within the catalog 930 may be added, removed, updated or otherwise modified by the rich media server 950.

The resulting embedded listing catalog 930 not only creates a robust and dynamic compilation of auction listings but also expands the number of potential buyers that view the auction listings. In the case of the golf-related catalog, potential buyers may view the catalog as a result of logging on to a golf course site and scheduling a tee time. A number of these golfers may not normally participate in auctions on auction sites so the number of potential bidders in these auctions will expand.

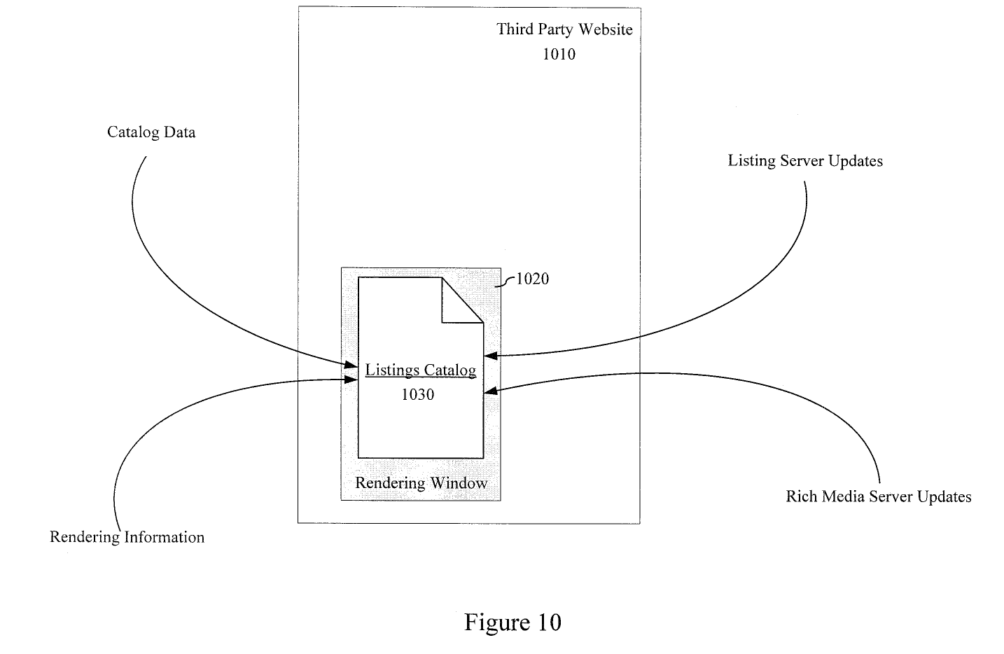

FIG. 10 illustrates an exemplary listing catalog being embedded within a micro-community, third-party website according to various embodiments of the invention. As already discussed, a listings catalog 1030 may be generated and rendered within a rendering window 1020 embedded in a third-party website 1010. The rendering window 1020 allows the selection and positioning of listings and/or data from outside servers to be performed relative to at least one criteria.

The catalog is considered to be rendered into the rendering window because the program that manages the rendering window has no advance knowledge of what to display in the window and depends on the data contained in the rendering information. By way of contrast, consider two other possible methods of displaying a catalog into the rendering window.

The first approach is to construct a program that displays an essentially fixed catalog. Such a program can take visualization hints at startup to provide the appearance of customization but the overall layout and function is effectively fixed and unchanged with the only distinction between different catalogs being the visual cues an the items displayed within the catalog itself. From the catalog provider point of view, the only degree of customization is the selection of color scheme and the selection of products that appear in the catalog. In this example, the features and functionality of all catalogs was determined at the time the program was created and cannot be changed unless the underlying catalog program is changed.

The second approach is similar to the first but consists of breaking the catalog program into distinct sections such as a search section, product listing section, product detail section, etc. Similar to the previous example, each section consists of pre-defined fixed functionality defined at the time the program or sub-program was created. Again, from the point of view of the catalog provider, the overall functionality still remains fixed but with the option of including or excluding certain sections of the catalog. As before, in order to change the catalog functionality requires the underlying program to be changed.

The rendering approach is distinct in that the underlying program has no distinct concept of a catalog, but rather has an understanding of visual components such as text, images, graphical components, and rich-media widgets. These raw components are written such that a rendering program can create, configure, manage, and display unique instances of these components within the rendering window. This rendering approach allows the catalog functionality to be described in the rendering information without having to define that functionality in advance at the time the rendering program was written. It also means that new catalog functionality can be defined without having to rewrite the underlying rendering program as would be the case in the previous examples. Furthermore, if a rigid framework of fixed functionality, such as provided by the previous two examples, is desired, this can easily be accomplished by using template technology. For example, certain text editors allow a user to create virtually any document they want, but it also provides a collection of templates that restrict flexibility in exchange for ease of use given a particular task such as creating letterhead or envelopes. Similarly, since all functionality displayed within the rendering window is controlled by a stream of rendering data, this rendering data can be the result of combining a catalog template with user provided attributes and because this is data driven instead of programmed into the underlying rendering program, it is possible to define both new and completely distinct functionality by authoring a new rendering data stream instead of writing a new program.

By rendering the listings catalog 1030 within the embedded rendering window; different functionality may be realized within the catalog 1030 on the third-party website. The rendering window 1020 allows data/listings within the catalog 1030 to reflect re-pricing, restocking/automated refilling of items, collaboration, prioritization of items based on the number of sales, prioritization based on a pricing or auction, prioritization based on a person's history, adjustments to content/items particular to one seller or group of sellers, and the ability to delete or embed seller pages en mass, adjustments relative to real-time auction pricing updates. One skilled in the art will recognize that the rendering window 1020 may support other functions that may be realized within the rendering window.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. A method for creating an electronic commerce listings catalog, the method comprising:
receiving a plurality of electronic commerce listings relating to a plurality of goods for sale, the plurality of electronic commerce listings comprising both data and metadata;
identifying a first subset of electronic commerce listings, within the plurality of electronic commerce listings, based on at least one shared characteristic in each of the listings within the first subset of electronic commerce listings; and
combining the first subset of electronic commerce listings into a listings catalog, the listings catalog operable within a rich media environment and comprising data that is updated from a listings server.

2. The method of claim 1 wherein the first subset of electronic commerce listings includes at least one auction listing.

3. The method of claim 2 wherein the first subset of electronic commerce listings comprises auction listings on at least two auction sites.

4. The method of claim 3 further comprising the step of rendering the listings catalog in a rendering window embedded in a third party website.

5. The method of claim 4 further comprises the steps of:
updating a first set of data within at least one of the listings within the first subset of electronic commerce listings from an auction site; and
updating a second set of data within the at least one of the listings within the first subset of electronic commerce listings from a catalog site.

6. The method of claim 5 wherein the first set of data comprises current auction bid information related to the at least one of the listings.

7. The method of claim 5 wherein the first set of data comprises time limit information related to the at least one of the listings.

8. The method of claim 5 wherein the second set of data comprises catalog index information.

9. The method of claim 5 wherein the second set of data comprises a table of contents for the listings catalog.

10. The method of claim 1 wherein the at least one shared characteristic includes a type of product being sold.

11. The method of claim 1 wherein the at least one shared characteristic includes a location of a product seller.

12. The method of claim 1 wherein the at least one shared characteristic includes a seller ranking by an auction site.

13. The method of claim 1 further comprising the step of associating the listings catalog with a micro-community.

14. The method of claim 1 wherein a first electronic commerce listing, within the plurality of electronic listings, os generated using a template that defines a layout of the first electronic commerce listing.

15. A method for creating and maintaining an electronic commerce micro-community, the method comprising:
grouping a first set of electronic commerce purchasers based at least in part on a first characteristic;
grouping a first set of electronic commerce sellers based at least in part on a second characteristic;
defining a set of transaction rules for the electronic commerce micro-community;
publishing a listings catalog associated with the electronic commerce micro-community; and
limiting participation within the micro-community to users within the first set of electronic commerce purchasers and the first set of electronic commerce sellers.

16. The method of claim 15 wherein transactions related to the plurality of listings catalog are performed exclusively by members of the micro-community.

17. The method of claim 15 wherein the first characteristic is a geographical location shared by the first set of electronic commerce purchasers.

18. The method of claim 15 wherein the first characteristic relates to a particular type of product.

19. The method of claim 15 wherein the first characteristics is a hobby shared by the first set of electronic commerce purchasers.

20. The method of claim 15 wherein membership within the micro-community is controlled by a user.

21. A system for creating a listings catalog, the system comprising:
a listing generator that generates a plurality of electronic commerce listings using user-provided data and metadata;
an index generator that creates a listings index from the plurality of electronic commerce listings; and
a catalog generator that analyzes the listings index relative to at least one criteria and generates a listings catalog from a first subset in the plurality of listings.

22. The system of claim 21 wherein the listings index is organized in a tree hierarchy.

23. The system of claim 21 wherein the plurality of templates operates within a rich media environment.

24. The system of claim 23 wherein the rich media environment is a flash environment.

25. The system of claim 21 wherein the listings catalog is embedded within a third-party website.

26. The system of claim 21 wherein the listings catalog comprises a plurality of auction listings.

27. The system of claim 26 wherein the plurality of listings relates to a plurality of auction sites.

28. The system of claim 26 wherein at least one of the listings within the plurality of listings relates to eBay.

29. A computer program product embodied on a computer readable medium for creating a electronic commerce listings catalog, the computer program product comprising computer instructions for:
receiving a plurality of electronic commerce listings relating to a plurality of goods for sale, the plurality of electronic commerce listings comprising both data and metadata;
identifying a first subset of electronic commerce listings, within the plurality of electronic commerce listings, based on at least one shared characteristic in each of the listings within the first subset of electronic commerce listings; and
combining the first subset of electronic commerce listings into a listings catalog, the listings catalog operable within a rich media environment and comprising data that is updated from a listings server.

30. The computer program product of claim 29 wherein the first subset of electronic commerce listings includes at least one auction listing.

31. The computer program product of claim 30 wherein the first subset of electronic commerce listings comprises auction listings on at least two auction sites.

32. The computer program product of claim 31 further comprising the step of rendering the listings catalog within a rendering window embedded in a third party website.

33. The computer program product of claim 32 further comprises the steps of:
updating a first set of data within at least one of the listings within the first subset of listings from an auction site; ad
updating a second set of data within the at least one of the listings within the first subset of listings from a catalog site.

34. A method for creating and maintaining an auction listings catalog within a website, the method comprising:
creating an auction listings catalog from a listings index related to a plurality of electronic commerce listings;
rendering the auction listings catalog within a rendering window embedded in the website;
updating auction-related data within the auctions listings catalog from at least one auction site;
updating listings data within the auction listings catalog from at least one rich media server; and
monitoring user activity related to the auction listings catalog.

35. The method of claim 34 wherein the at least one auction site comprises two distinct auction sites.

36. The method of claim 34 wherein the at least one auction site comprises an eBay listing.

37. The method of claim 34 wherein the auction listings catalog is associated with at least one micro-community.

38. The method of claim 34 wherein the auction listings catalog is generated and maintained within a rich media environment.

39. A method for creating and maintaining an embedded electronic commerce catalog, the method comprising:
receiving electronic commerce listing data related to a plurality of electronic commerce listings;
receiving rendering information that provides at least one characteristic of a first listing within the plurality of electronic commerce listings;
creating a catalog layout based at least in part on the rendering information; and
rendering the electronic commerce catalog within a third-party website using the catalog layout and the electronic commerce listing data.

40. The method of claim 39 further comprising the step of updating at least a portion of the electronic commerce listing data within the electronic commerce catalog from a listings server.

41. The method of claim 39 wherein positions of the plurality of electronic commerce listings within the electronic commerce catalog is at least partially defined by a listings prioritization.

42. The method of claim 41 wherein the listings prioritization relates to a criteria selected from a group consisting of a total number of items for sale in a listing, item pricing, auction pricing, a person's user history, and adjustments to items particular to one seller or group of sellers.

43. The method of claim 40 wherein the plurality of electronic commerce listings comprises at least one auction listing.

44. The method of claim 40 wherein the at least a portion of the electronic commerce listing data is intermittently updated from the listings server.

45. The method of claim 44 wherein the at least a portion of the electronic commerce listing data is intermittently updated at a rate sufficient to maintain an approximate realtime representation of the electronic corner listing data in the electronic commerce catalog.

46. The method of claim 40 wherein the rendering information comprises at least one type of information selected from a group consisting of configuration data, visual data, listing components, rich media functionality, prioritization data, location of listings within catalog, security and user monitoring data.

47. The method of claim 40 wherein the catalog layout is changed in response to information received from a rich media server.

48. The method of claim 40 wherein relative positions of the plurality of electronic commerce listings within the electronic commerce catalog are changed in response to information received from the listings server.

49. An embedded electronic commerce catalog comprising:
a plurality of electronic commerce listings that contain electronic commerce listings data describing items available for purchase; and
a catalog layout that is generated from rendering information related to the plurality of electronic commerce listings and that defines relative positions within the electronic commerce catalog for the plurality of electronic commerce listings.

50. The embedded electronic commerce catalog of claim 49 further comprising an embedded catalog maintenance module that updates at least a portion of the electronic commerce listings data from a listings server.

51. The embedded electronic commerce catalog of claim 50 wherein the embedded catalog maintenance module updates at least a portion of the electronic commerce listings at a rate sufficient for approximately realtime maintenance of the electronic commerce catalog.

52. The embedded electronic commerce catalog of claim 50 wherein the embedded catalog maintenance module updates the at least a portion of the electronic commerce listings at a rate sufficient for realtime maintenance of the electronic commerce catalog.

53. The embedded electronic commerce catalog of claim 49 wherein the plurality of electronic commerce listings comprises at least one auction listing.

54. The embedded electronic commerce catalog of claim 49 wherein the rendering information comprises information selected from a group consisting of configuration data, visual data, listing components, rich media functionality, prioritization data, location of listings within catalog, security and user monitoring data.

55. The embedded electronic commerce catalog of claim 49 wherein positions of the plurality of electronic commerce listings within the electronic commerce catalog is at least partially defined by a listings prioritization.

56. The embedded electronic commerce catalog of claim 55 wherein the listings prioritization relates to a criteria selected from a group consisting of a total number of items for sale in a listing, item pricing, auction pricing, a person's user history, and adjustments to items particular to one seller or group of sellers.
